(19) United States
(12) Patent Application Publication
(10) Pub. No.: US 2009/0041254 A1
(43) Pub. Date: Feb. 12, 2009

(54) SPATIAL AUDIO SIMULATION

(75) Inventors: Craig Jin, New South Wales (AU); Alan Ho Lun Kan, New South Wales (AU); Andre van Schaik, New South Wales (AU)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: PERSONAL AUDIO PTY LTD, Sydney NSW (AU)

(21) Appl. No.: 12/090,799

(22) PCT Filed: Oct. 11, 2006
(86) PCT No.: PCT/AU2006/001497

§ 371 Date: Sep. 30, 2008

(30) Foreign Application Priority Data
Oct. 20, 2005 (AU) 2005905817

(51) Int. Cl. H04R 5/00

(52) U.S. Cl. 381/1

(57) ABSTRACT

Equipment (1) for producing binaural sound signals for virtual spatial audio includes a receiver (4) for receiving signals that should be rendered as virtual spatial audio. A signal processor (3) is in communication with the receiver (4) for processing the received audio signals, performing computations using a distance variation function for varying a target distance of the virtual sound and rendering the received signals as virtual spatial audio. The equipment (1) further includes a connector (6) to which an output device is connectable, the output device being controlled by the signal processor (3) to output binaural sound signals for virtual spatial audio at the target distance.

### CROSS-REFERENCE TO RELATED APPLICATIONS

The present application claims priority from Australian Provisional Patent Application No 2005905817 filed on 20 Oct. 2005, the contents of which are incorporated herein by reference.

### FIELD OF THE INVENTION

The present invention relates to the simulation of spatial audio at varying distances. More particularly, the invention relates to a method of, and equipment for, rendering virtual spatial audio at varying distances in such a manner that the listener clearly perceives the virtual sound source at a precise distance and direction in space.

### BACKGROUND TO THE INVENTION

The applicants are aware of various methods for producing virtual spatial audio that varies with distance. One particular region of space in which distance control is especially important for virtual auditory displays is the near-field region of space. The near-field region of space can be described as comprising those spatial locations within easy reach of the listener, i.e., roughly within arms' reach. The most common method for accurately positioning a virtual sound source in the near field utilises head-related transfer functions (HRTFs) that have been acoustically recorded in the near field. HRTFs are acoustic transfer functions used to simulate virtual auditory space. The near-field HRTFs are acoustic transfer functions that describe the pressure transformation from a position in the near field to the entrance of the ear canals of the subject or mannequin in respect of which the measurements have been recorded. Near-field acoustic HRTFs can be recorded using known impulse measurement techniques. The near-field HRTFs that have been accurately recorded can then be used to synthesize virtual sound sources using appropriate filtering techniques. When presented properly over headphones, these virtual sound sources perceptually appear to originate from a location in the near field that is determined by the measurement position of the near-field HRTFs.

Other methods for producing virtual spatial audio in the near-field region of space rely on applying signal modifications to virtual sound sources in the far-field region of space. The far-field region of space can be described as comprising those spatial locations more distant from the listener than the near-field region of space, i.e., approximately greater than 1-2 metres away from the listener.

A reason for trying to synthesize near-field virtual sound sources from far-field virtual sound sources derives from the fact that recording HRTFs in the near-field region of space is difficult and time-consuming. In fact, it is even more difficult than recording HRTFs in the far-field region of space. Some of the difficulties associated with near-field HRTF recordings are: (i) the finite dimensions of the loudspeaker diaphragm invalidates the ideal point-source approximation and (ii) small errors in the position of the loudspeaker relative to the head can induce large changes in the HRTFs.

It is necessary to distinguish between signal manipulations aimed at far-field distance modification and true near-field manipulations. For example, it is common to modify the distance perception of far-field virtual sound sources by changing the relative ratio of the direct sound energy to reverberant sound energy and also by applying low-pass filtering to simulate air absorption. These signal manipulations are generally aimed at varying the perceived distance of virtual sound sources that remain in the far field and do not account directly for systematic changes in the HRTFs associated with the near field.

Another method for producing virtual spatial audio in the near-field region of space is to use a binaural synthesis of a near-field control (NFC) ambisonic approach in which virtual loudspeaker playback is simulated using HRTFs. The NFC ambisonic approach to virtual spatial audio relies on a spherical harmonic expansion of the virtual sound field. More precisely, the sound field produced by a near-field point source can be simulated using loudspeakers that are modelled as point-source loudspeakers. The point-source approximation provides curvature to the wavefront and differs from the plane-wave model of loudspeakers that have traditionally been used in ambisonic sound displays. The basic principle behind ambisonic virtual spatial audio is to re-create a spatial sound field that is valid up to a certain order of spherical harmonic approximation. NFC ambisonic calculations rely on point-source spherical harmonic approximations. Binaural synthesis of NFC ambisonic loudspeaker playback then relies on using HRTF filters to simulate the array of loudspeakers.

The disadvantage of earlier methods for producing virtual spatial audio in the near-field region of space is that they lack a simple, accurate and direct mathematical model that can be used in real-time to derive near-field HRTF filters. The disadvantage of current computer sound cards is that their near-field sound control relies on simple modulations of interaural level difference that are not sufficiently accurate. The disadvantage of binaural synthesis based on NFC ambisonics is that the model is extremely complicated and is of insufficient accuracy.

Several technical terms are used below and are defined as follows. “Head-related transfer functions (HRTFs)” are filtering functions that are used to simulate virtual auditory space. There is generally one HRTF for each ear and for each location in space. In this specification, HRTF filtering functions are generalised to include any filtering function that represents a pressure transformation from one location in space to another. A “distance variation function (DV)” is a mathematical quantity that is used to derive an HRTF filter at a new, target, location from a known HRTF at some other initial location. An “initial function, S_{I}”, and a “target function, S_{T}”, refer to mathematical quantities associated with an initial location in space and a target location in space, respectively, that can be used to calculate a distance variation function as defined above. A “head-like surface” is a rigid surface that has acoustic scattering properties that share some similarity with an object that has had HRTF acoustic measurements performed. Examples of a head-like surface include a rigid sphere, ellipsoid, prolate spheroid, acoustic mannequin, a human head, a human head model, or the like.

### SUMMARY OF THE INVENTION

According to a first aspect of the invention, there is provided a method for producing virtual spatial audio, the method including providing a head-related transfer function (HRTF), H_{I}, corresponding to a direction, \hat{x}, and a distance, D_{I};

determining a distance variation function, DV, that models the variation of HRTFs with distance; and

using a signal processor to apply the distance variation function, DV, and the HRTF, H_{I}, to sounds to produce binaural sounds corresponding to a direction, ŷ, and a distance, D_{T}.

It will be appreciated that either DV or H_{I}, or both, may be applied directly to the sounds. Thus, H_{I} may be applied directly to the sounds first followed by DV being applied to the result or vice versa However, in a preferred embodiment, the method may include applying the distance variation function, DV, to H_{I} in order to obtain a head-related transfer function, H_{T}, corresponding to the direction, ŷ, and a distance, D_{T}.

The method may include applying the distance variation function to H_{I} in the frequency domain as H_{T}=DV·H_{I}. Instead, the method may include applying the distance variation function to H_{I} in the time domain as H_{T}=DVconvolveH_{I}.

The method may include using the signal processor to filter the sounds with the HRTF, H_{T}, to produce the binaural sound signals.

Preferably, the method includes using an acoustic actuator to deliver sound to the listener that is consistent with the virtual spatial audio binaural sound signals.

Further, the distance, D_{I},may be in a far field and the distance, D_{T}, may be in a near field.

The method may include determining the distance variation function, DV, that models the variation of HRTFs with distance by determining an initial function, S_{I}, for initial distance D_{I};

determining a target function, S_{T}, for target distance D_{T}; and

determining a distance variation function, DV, from S_{I} and S_{T}.

The initial function may characterise a solution to an acoustic wave equation for scattering of sound around a head-like surface for a point-source of sound located at the initial distance from the head-like surface. The target function may characterise a solution to an acoustic wave equation for scattering of sound around a head-like surface for a point-source of sound located at the target distance from the head-like surface.

The method may be performed in the frequency domain using transfer functions and may include calculating the distance variation function as

$$D V = \frac{{S}_{T}}{{S}_{I}} .$$

Instead, the method may be performed in the time domain using filter functions and may include calculating the distance variation function as DV=S_{T} deconvolve S_{I}.

The method may include calculating the initial and target functions according to analytical solutions of pressure on the surface of a rigid head-like surface due to a source of sound at the initial and target distances, respectively, away from the head-like surface. Thus, the method may include employing, in the analytical solutions, a radius for the rigid head-like surface that matches that corresponding to a human subject that corresponds to the HRTFs. Instead, the method may include calculating the analytical solutions using computationally fast iterative methods of solution.

The method may include deriving the initial and target functions from acoustic measurements of pressure on the surface of a rigid head-like surface due to a source of sound at the initial and target distances, respectively, away from the head-like surface.

The method may include interpolating one of the initial function, the target function and both the initial and the target functions from data corresponding to distances other than the initial or target distances.

In one embodiment, the method may include selecting the direction ŷ to be the same as the direction \hat{x}. In another embodiment, the method may include relating the direction ŷ to the direction \hat{x} by a parallax effect that depends on distance.

According to a second aspect of the invention, there is provided a method for determining a distance variation function that models the variation of HRTFs with distance, the method including:

determining an initial function, S_{I}, for the initial distance;

determining a target function, S_{T}, for the target distance; and

determining a distance variation function, DV, from S_{I} and S_{T}.

The method may be performed in the frequency domain using transfer functions and may include calculating the distance variation function as

$$D V = \frac{{S}_{T}}{{S}_{I}} .$$

Instead, the method may be performed in the time domain using filter functions and may include calculating the distance variation function as DV=S_{T} deconvolve S_{I}.

The method may include calculating the initial and target functions according to analytical solutions of pressure on the surface of a rigid head-like surface due to a source of sound at the initial and target distances, respectively, away from the head-like surface. The method may include employing, in the analytical solutions, a radius for the rigid head-like surface that matches that corresponding to a human subject that corresponds to the HRTFs. Instead, the method may include calculating the analytical solutions using computationally fast iterative methods of solution.

The method may include deriving the initial and target functions from acoustic measurements of pressure on the surface of a rigid head-like surface due to a source of sound at the initial and target distances, respectively, away from the head-like surface.

The method may include interpolating one of the initial function, the target function and both the initial and the target functions from data corresponding to distances other than the initial or target distances.

According to a third aspect of the invention, there is provided a method for modifying a head-related transfer function (HRTF), H_{I}, corresponding to a direction, \hat{x}, and a distance, D_{I}, to a head-related transfer function, H_{T}, corresponding to a direction, ŷ, and distance, D_{T}, the method including

determining a distance variation function, DV, that models the variation of HRTFs with distance; and

applying the distance variation function, DV, to H_{I} to obtain H_{T}.

The method may include determining the distance variation function using the method described above with reference to the second aspect of the invention.

The method may include applying the distance variation function to H_{I} in the frequency domain as H_{T}=DV·H_{I}. Instead, the method may include applying the distance variation function to H_{I} in the time domain as H_{T}=DVconvolveH_{I}.

The method may include selecting the direction ŷ to be the same as the direction \hat{x}. Instead, the method may include relating the direction ŷ to the direction \hat{x} by a parallax effect that depends on distance.

According to a fourth aspect of the invention, there is provided a method for producing binaural sound signals for virtual spatial audio, the method including modifying a head-related transfer function (HRTF), H_{I}, corresponding to a direction, \hat{x}, and a distance, D_{I}, to a head-related transfer function, H_{T}, corresponding to a direction, ŷ, and distance, D_{T}; and

using a signal processor to filter sounds with the modified HRTF, H_{T}, to produce binaural sound signals.

The method may include deriving the HRTF, H_{T}, using the method described above with reference to the third aspect of the invention.

According to a fifth aspect of the invention, there is provided a method for producing binaural sound signals for virtual spatial audio, the method including filtering input sounds with a head-related transfer function (HRTF), H_{I}, corresponding to a direction, \hat{x}, and a distance, D_{I}; and

using a signal processor to filter the sounds with a distance variation function, DV, that models the variation of HRTFs with distance.

The method may include deriving the distance variation function, DV, using the method described above with reference to the second aspect of the invention.

According to a sixth aspect of the invention, there is provided a method for producing virtual spatial audio, the method including producing binaural sound signals for virtual spatial audio; and

using an acoustic actuator to deliver sound to the listener that is consistent with the virtual spatial audio binaural sound signals.

The method may include producing the binaural sound signals using the method described above with reference to the fourth aspect or the fifth aspect of the invention.

According to a seventh aspect of the invention, there is provided equipment for producing virtual spatial audio, the equipment including:

a receiver for receiving signals to be rendered as virtual spatial audio;

a signal processor in communication with the receiver for processing the received audio signals, performing computations using a distance variation function for varying a target distance of the virtual sound and rendering the received signals as virtual spatial audio; and

a connector to which an output device is connectable, the output device being controlled by the signal processor to output binaural sound signals for virtual spatial audio at the target distance.

The equipment may include the output device which delivers sound to a listener that is consistent with near-field binaural sound signals.

### BRIEF DESCRIPTION OF THE DRAWING

An embodiment of the invention is now described by way of example with reference to the accompanying drawings in which:

FIG. 1 shows, schematically, equipment, in accordance with an embodiment of the invention, for producing virtual spatial audio; and

FIG. 2 shows a flow chart of a method, in accordance with an embodiment of the invention, for producing virtual spatial audio.

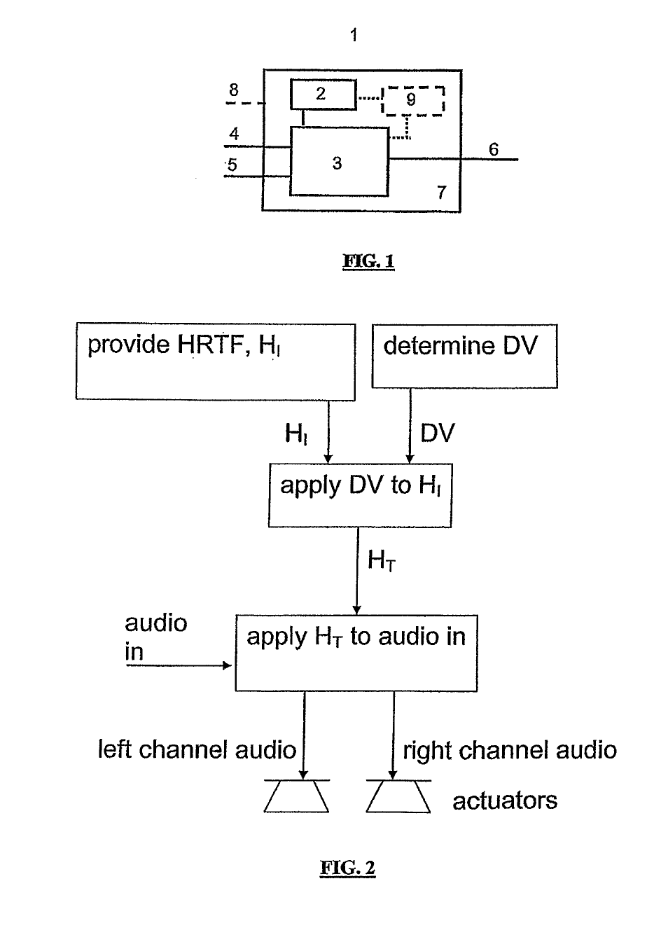

### DETAILED DESCRIPTION OF THE EXEMPLARY EMBODIMENT

In the drawing, reference numeral 1 generally designates equipment, in accordance with an embodiment of the invention, for producing virtual spatial audio. The equipment 1 includes an input data port 4 to receive an audio signal and an input data port 5 to receive an associated position signal that determines a target location (distance and direction) at which the audio signal should be spatially rendered with respect to a listener's personal virtual auditory space. Clearly, both the audio signal and the position signal can vary in time. In some embodiments, the audio signal and its associated position signal can be combined to form a single input signal.

The equipment 1 includes a computational unit 7 which includes a signal processor 3 and a data storage unit 2. The signal processor 3 may be replaced or supplemented with an optional microprocessor unit 9. There is also an output data port 6.

The signal processor 3 selects HRTF filters from the data storage unit 2 based on the intended direction, q̅=(r, θₖ, Φₖ), of the audio signal. The HRTF filters can be stored in the data storage unit 2 in various formats. In a preferred embodiment, the HRTF filters are stored in a compressed format (such as that obtained when a principal components analysis is performed on the HRTF data) with additional side information that can be used to interpolate an HRTF filter for any direction. The additional side information can be extracted from a set of HRTF filters for discrete directions in space using interpolation techniques such as a spherical spline algorithm or near-neighbour interpolation. Instead, the necessary HRTF filters can be obtained from an external source using an optional data communications port 8.

In a preferred embodiment, the signal processor 3 calculates a distance variation function, DV, based on the distance of the target location, DT, and the distance, D_{I}, associated with the HRTF filters stored in data storage unit 2. It is assumed that a distance variation function, DV, is required (e.g., D_{T} is not equal to D_{I} and at least one of D_{T} or D_{I} is in the near-field region of space). In a preferred embodiment, the signal processor 3 uses the analytical solution for sound scattering around a head-like surface in the form of a rigid sphere to derive an initial function, S_{I}, associated with distance, D_{I}, and a target function, S_{T}, associated with distance D_{T}. The pressure, pₛ(a, θₛ, Φₛ; k,r), at the surface of a rigid sphere of radius, a, at the location, x̅=(a, θₛ, Φₛ), due to a sinusoidal point-source of sound at a frequency, f, wave number,

$$k = \frac{2 π f}{c} ,$$

and at a location, q̅=(r, θₖ, Φₖ) , is given by:

$${p}_{s} ( a , {θ}_{s} , {ϕ}_{s} ; k , r ) = - 4 π \frac{c}{a} \frac{1}{ka} {\sum }_{n = 0}^{∞} \frac{{h}_{n} ( kr )}{{h}_{n}^{′} ( ka )} {\sum }_{m = - n}^{n} {Y}_{n}^{m} ( {θ}_{k} , {ϕ}_{k} ) {Y}_{n}^{m *} ( {θ}_{s} , {ϕ}_{s} ) ,$$

where c is the speed of sound, hₙ(kr)=jₙ(kr)+jₙ(kr) is a modified spherical Bessel function of the first kind of order n, and Yₙ^{m}(θ, Φ) is a spherical harmonic function of degree n and order m . The pressure, pₛ(a, θₛ, Φₛ; k,r), at the surface of the rigid sphere can be calculated for each desired wave number, k, in order to determine a pressure transfer function at the surface of the sphere due to a point-source of sound at a specified distance, r. Thus, in a preferred embodiment, the signal processor 3 calculates S_{I} for the distance D_{I} as: S_{I}=pₛ(a, θₛ, Φₛ; k, D_{I}). The signal processor 3 calculates S_{T} for the distance D_{T} as: S_{T}=pₛ(a, θₛ, Φₛ; k, D_{T}). The numerical value for a is determined by the size of the listener's head and can be pre-calculated from the set of HRTFs stored in the data storage unit 2 (e.g., using Kuhn's model). The numerical values for azimuth and elevation angles (θₛ, Φₛ) are determined by the location of the listener's ears on his/her head (Note that there is a separate HRTF filter and distance variation filter, DV, for each ear). The signal processor 3 then calculates the distance variation function as

$$D V = \frac{{S}_{T}}{{S}_{I}} .$$

The signal processor 3 determines the initial HRTF, H_{I}, based on the target direction, q̅=(r, θₖ, Φₖ), and the HRTF data stored in the data storage unit 2. In a preferred embodiment, a spherical spline interpolation method is used to determine the initial HRTF. In a preferred embodiment, the signal processor 3 takes the parallax effect into account and alters the target direction appropriately when determining the initial HRTF filter. The signal processor 3 then calculates the target HRTF, H_{T}, as H_{T}=DV·H_{I}.

The signal processor 3 applies the HRTF, H_{T}, to the received audio signal in order to derive binaural sound signals appropriate for simulating virtual auditory space in the near field. These binaural sound signals can be passed to an output device such as a set of headphones, a loudspeaker array, or other acoustic actuator via the output data port 6.

In the general method, HRTF filters are recorded acoustically at a specific measurement distance from the subject. HRTF filters are used to simulate virtual auditory space in the near field. A difficulty with the simulation of virtual auditory space in the near field is that the measurement distance may not be the same as the desired target distance for the sound signal in a simulated virtual auditory display. Typically, HRTF filters are acoustically recorded in what is referred to as the listener's far-field region of space. The far-field region of space is generally taken as the set of locations greater than one metre away from the listener. The defining characteristic for far-field locations is that a sound source in the far-field region of space can be approximated as a plane-wave sound source with a small approximation error. The consequence of the plane-wave sound source characteristic for the far-field region of space is that HRTF filters for a specific direction in space vary very little in spectral characteristic as a function of distance. The overall intensity of the sound will naturally vary with distance in the far-field region of space, but this can be accounted for by a simple scaling of the sound signal with an appropriate gain or attenuation factor. Thus, HRTF filters in the far-field region of space vary with direction only and not as a function of distance.

The near-field region of space, on the other hand, generally refers to locations within one metre of the subject and for this reason is referred to as the set of locations “within arms' reach.” There are several technical difficulties associated with simulating near-field sounds in virtual auditory space. The primary difficulty is that the HRTF filters corresponding to the near-field region of space change as a function of distance. Thus a different HRTF filter is needed for each and every distance in the near field of the listener. HRTF filters are difficult and time-consuming to record acoustically. Currently, there are very few HRTF filter databases that have been recorded for the near-field region of space. There are many difficulties associated with acoustically recording HRTF filters in the near-field region of space such as the precise positioning required of the sound source and the difficulty in creating a broadband point-source of sound.

Given the difficulties associated with simulating high-fidelity virtual auditory space in the near-field region of space, the great advantage of the invention is that is provides a means to produce high-fidelity HRTF filters for the near-field region of space. Furthermore, the invention is able to produce high-fidelity, near-field HRTF filters in real-time and on-the-fly to match the needs of any virtual auditory display. The calculation of the distance variation function, DV, can be performed very quickly using standard iterative methods of calculation. Another advantage of the invention is that the near-field HRTF filters are more accurate and easier to calculate than for any other known method, such as the binaural NFC ambisonic method.

Yet a further advantage of the invention is that it enables the simulation of virtual spatial audio in a region of space, the near-field, that strongly influences the human perception of immersion and realism in an auditory space. Accurate simulation of sounds in the near field greatly enhances the realism of the auditory display. Furthermore, separation of different talkers in distance also leads to significant improvement in speech intelligibility. Thus in a virtual auditory display that combines many different talkers, the ability to accurately simulate talkers located in the near field will lead to more intelligible and usable virtual auditory displays.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for producing virtual spatial audio, the method including providing a head-related transfer function (HRTF), H_{I}, corresponding to a direction, \hat{x}, and a distance, D_{I};
determining a distance variation function, DV, that models the variation of HRTFs with distance; and
using a signal processor to apply the distance variation function, DV, and the HRTF, H_{I}, to sounds to produce binaural sounds corresponding to a direction, ŷ, and a distance, D_{T}.

2. The method of claim 1 which includes applying the distance variation function, DV, to H_{I} in order to obtain a head-related transfer function, H_{T}, corresponding to the direction, ŷ, and the distance, D_{T}

3. The method of claim 2 which includes applying the distance variation function to H_{I} in the frequency domain as H_{T}=DV·H_{I}.

4. The method of claim 2 which includes applying the distance variation function to H_{I} in the time domain as H_{T}=DVconvolveH_{I}.

5. The method of claim 2 which includes using the signal processor to filter the sounds with the HRTF, H_{T}, to produce the binaural sound signals.

6. The method of claim 1 which includes using an acoustic actuator to deliver sound to the listener that is consistent with the virtual spatial audio binaural sound signals.

7. The method of claim 1 in which the distance, D_{I}, is in a far field and the distance, D_{T}, is in a near field.

8. The method of claim 1 which includes determining the distance variation function, DV, that models the variation of HRTFs with distance by
determining an initial function, S_{I}, for initial distance D_{I};
determining a target function, S_{T}, for target distance D_{T}; and
determining a distance variation function, DV, from S_{I} and S_{T}.

9. The method of claim 8 which is performed in the frequency domain using transfer functions and which includes calculating the distance variation function as
$$D V = \frac{{S}_{T}}{{S}_{I}} .$$

10. The method of claim 8 which is performed in the time domain using filter functions and which includes calculating the distance variation function as DV=S_{T} deconvolve S_{I}.

11. The method of claim 8 which includes calculating the initial and target functions according to analytical solutions of pressure on the surface of a rigid head-like surface due to a source of sound at the initial and target distances, respectively, away from the head-like surface.

12. The method of claim 11 which includes employing, in the analytical solutions, a radius for the rigid head-like surface that matches that corresponding to a human subject that corresponds to the HRTFs.

13. The method of claim 11 which includes calculating the analytical solutions using computationally fast iterative methods of solution.

14. The method of claim 8 which includes deriving the initial and target functions from acoustic measurements of pressure on the surface of a rigid head-like surface due to a source of sound at the initial and target distances, respectively, away from the head-like surface.

15. The method of claim 8 which includes interpolating one of the initial function, the target function and both the initial and the target functions from data corresponding to distances other than the initial or target distances.

16. The method of claim 1 which includes selecting the direction ŷ to be the same as the direction \hat{x}.

17. The method of claim 1 which includes relating the direction ŷ to the direction \hat{x} by a parallax effect that depends on distance.

18. A method for determining a distance variation function that models the variation of HRTFs with distance, the method including:
determining an initial function, S_{I}, for the initial distance;
determining a target function, S_{T}, for the target distance; and
determining a distance variation function, DV, from S_{I} and S_{T}.

19. The method of claim 18 which is performed in the frequency domain using transfer functions and which includes calculating the distance variation function as
$$D V = \frac{{S}_{T}}{{S}_{I}} .$$

20. The method of claim 18 which is performed in the time domain using filter functions and which includes calculating the distance variation function as DV=S_{T} deconvolve S_{I}.

21. The method of claim 18 which includes calculating the initial and target functions according to analytical solutions of pressure on the surface of a rigid head-like surface due to a source of sound at the initial and target distances, respectively, away from the head-like surface.

22. The method of claim 21 which includes employing, in the analytical solutions, a radius for the rigid head-like surface that matches that corresponding to a human subject that corresponds to the HRTFs.

23. The method of claim 21 which includes calculating the analytical solutions using computationally fast iterative methods of solution.

24. The method of claim 18 which includes deriving the initial and target functions from acoustic measurements of pressure on the surface of a rigid head-like surface due to a source of sound at the initial and target distances, respectively, away from the head-like surface.

25. The method of claim 18 which includes interpolating one of the initial function, the target function and both the initial and the target functions from data corresponding to distances other than the initial or target distances.

26. A method for modifying a head-related transfer function (HRTF), H_{I}, corresponding to a direction, \hat{x}, and a distance, D_{I}, to a head-related transfer function, H_{T}, corresponding to a direction, ŷ, and distance, D_{T}, the method including
determining a distance variation function, DV, that models the variation of HRTFs with distance; and
applying the distance variation function, DV, to H_{I} to obtain H_{T}.

27. The method of claim 26 which includes determining the distance variation function using the method of claim 18.

28. The method of claim 26 which includes applying the distance variation function to H_{I} in the frequency domain as H_{T}=DV·H_{I}.

29. The method of claim which includes applying the distance variation function to H_{I} in the time domain as H_{T}=DVconvolveH_{I}.

30. The method of claim 26 which includes selecting the direction ŷ to be the same as the direction \hat{x}.

31. The method of claim 26 which includes relating the direction ŷ to the direction \hat{x} by a parallax effect that depends on distance.

32. A method for producing binaural sound signals for virtual spatial audio, the method including
modifying a head-related transfer function (HRTF), H_{I}, corresponding to a direction, \hat{x}, and a distance, D_{I}, to a head-related transfer function, H_{T}, corresponding to a direction, ŷ, and distance, D_{T}; and
using a signal processor to filter sounds with the modified HRTF, H_{T}, to produce binaural sound signals.

33. The method of claim 32 which includes deriving the HRTF, H_{T}, using the method of claim 26.

34. A method for producing binaural sound signals for virtual spatial audio, the method including
filtering input sounds with a head-related transfer function (HRTF), H_{I}, corresponding to a direction, \hat{x}, and a distance, D_{I}; and
using a signal processor to filter the sounds with a distance variation function, DV, that models the variation of HRTFs with distance.

35. The method of claim 34 which include deriving the distance variation function, DV, using the method of claim 18.

36. A method for producing virtual spatial audio, the method including
producing binaural sound signals for virtual spatial audio; and
using an acoustic actuator to deliver sound to the listener that is consistent with the virtual spatial audio binaural sound signals.

37. The method of claim 36 which includes producing the binaural sound signals using the method of claim 32.

38. Equipment for producing virtual spatial audio, the equipment including:
a receiver for receiving signals to be rendered as virtual spatial audio;
a signal processor in communication with the receiver for processing the received audio signals, performing computations using a distance variation function for varying a target distance of the virtual sound and rendering the received signals as virtual spatial audio; and
a connector to which an output device is connectable, the output device being controlled by the signal processor to output binaural sound signals for virtual spatial audio at the target distance.

39. The equipment of claim 38 which includes the output device which delivers sound to a listener that is consistent with near-field binaural sound signals.
